(19) United States
(12) Patent Application Publication
(10) Pub. No.: US 2025/0165543 A1
(43) Pub. Date: May 22, 2025

(54) AUTOMATIC GENERATION OF FACETS USING A LARGE LANGUAGE MODEL

(71) Applicant: Google LLC, Mountain View, CA (US)

(72) Inventor: Hari Bhaskar SANKARANARAYANAN, Bangalore (IN)

(73) Assignee: Google LLC, Mountain View, CA (US)

(21) Appl. No.: 18/740,614

(22) Filed: Jun. 12, 2024

(30) Foreign Application Priority Data
Nov. 20, 2023 (IN) 202311078613

(51) Int. Cl. G06F 16/9535

(52) U.S. Cl. CPC G06F 16/9535

(57) ABSTRACT

Implementations described herein relate to methods, systems, and computer-readable media to automatically generate facets and present facets in a user interface. In some implementations, a method includes obtaining a plurality of items of user-generated content associated with an entity. The method further includes providing a prompt to a large language model (LLM) to analyze the plurality of items to generate a plurality of facets. The method further includes generating a user interface that includes information about the entity and one or more user interface elements corresponding to a respective facet. The method further includes receiving user selection of a particular user interface element and updating the user interface to display one or more items of the plurality of items of user-generated content that are associated with the facet corresponding to the particular user interface element.

### CROSS-REFERENCE TO RELATED APPLICATIONS

The present application claims priority to Indian Provisional Patent Application No. 202311078613, filed on Nov. 20, 2023, and titled “Automatic Generation of Facets Using a Large Language Model,” which is incorporated by reference herein in its entirety.

### BACKGROUND

Search facets are a type of filter that enable a user to add specific contextual options to a web page (e.g., search results, or other content) to narrow down the search results. For example, on an e-commerce portal, relatively broad search queries or filters (e.g., “laptops”) can result in a large number of matching products being returned. Search facets, which can be attributes specific to laptops (e.g., screen-size, CPU speed, etc.), can enable users to narrow down search results without having to type in additional text. Search facets may be represented in the user interface (UI) via a suitable UI element such as checkboxes, tappable boxes, etc. and enable the user to contextualize the search to narrower attributes of interest. On a review portal, relatively broad search filters (e.g., “restaurants near me”) can result in a large number of matching options. Search facets in this context can include attributes relevant to restaurants.

Many user interfaces, including in search engines, e-commerce applications, digital maps, etc. include features that enable a user to filter information. For example, in an e-commerce application, a user may search for a product category (e.g., “laptops”) and filter by one or more product attributes (e.g., “>8 GB memory,” “14-inch display,” “storage type,” etc.). In such interfaces, the filters may be referred to as facets.

In conventional user interfaces, facets may be preset based on the information, e.g., facets for computers may be preselected (e.g., manually) by an e-commerce application provider, to enable users to filter information along the dimensions represented by the facets. Such facets, when automatically generated, may be generated from product attributes stored in a structured form, e.g., in a database. However, such user interfaces cannot include facets that are not preselected or that are based on unstructured data.

It may be possible to automatically generate facets based on unstructured data such as text (e.g., user-generated text) based on identifying keywords. However, such techniques may not adequately represent the semantic concepts that are included in the text.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to methods, devices, and computer-readable media to automatically generate facets from unstructured data, e.g., user-generated content (UGC) including text, images, audio, video, or combinations thereof. A large language model is trained and utilized to analyze UGC to automatically identify facets.

In some implementations, a computer-implemented method includes obtaining a plurality of items of user-generated content, wherein each item of the user-generated content includes at least one of text, image, audio, video, or combinations thereof, and wherein each item of the user-generated content is associated with an entity. The method further includes providing a prompt to a large language model (LLM) to analyze the plurality of items to generate a plurality of facets. The method further includes generating a user interface that includes information about the entity and one or more user interface elements, each user interface element corresponding to a respective facet of the plurality of facets. The method further includes receiving user selection of a particular user interface element of the one or more user interface elements. The method further includes, responsive to the user selection of the particular user interface element, updating the user interface to display one or more items of the plurality of items of user-generated content that are associated with the facet corresponding to the particular user interface element.

In some implementations, the method further includes pruning the plurality of facets.

In some implementations, each facet of the plurality of facets is associated with a respective category, and the computer-implemented method further includes storing the category associated with the facet corresponding to the particular user element in a database. In some implementations, the method further includes identifying one or more particular categories that meet a user selection threshold. In these implementations, providing the prompt to the LLM includes providing the prompt that includes the one or more particular categories.

In some implementations, generating the user interface includes identifying a subset of facets that match a user profile or a user context, and generating the one or more user interface elements, each user interface element corresponding to a respective facet of the subset of facets.

In some implementations, a computing device includes a processor and a memory with instructions stored thereon, that cause the processor perform operations that include obtaining a plurality of items of user-generated content, wherein each item of the user-generated content includes at least one of text, image, audio, video, or combinations thereof, and wherein each item of the user-generated content is associated with an entity. The operations further include providing a prompt to a large language model (LLM) to analyze the plurality of items to generate a plurality of facets. The operations further include generating a user interface that includes information about the entity and one or more user interface elements, each user interface element corresponding to a respective facet of the plurality of facets. The operations further include receiving user selection of a particular user interface element of the one or more user interface elements. The operations further include, responsive to the user selection of the particular user interface element, updating the user interface to display one or more items of the plurality of items of user-generated content that are associated with the facet corresponding to the particular user interface element.

In some implementations, the memory includes further instructions stored thereon that, when executed by the processor cause the processor to perform further operations that include pruning the plurality of facets.

In some implementations, each facet of the plurality of facets is associated with a respective category, and wherein the operations further include storing the category associated with the facet corresponding to the particular user element in a database.

In some implementations, the memory includes further instructions stored thereon that, when executed by the processor cause the processor to perform further operations that include identifying one or more particular categories that meet a user selection threshold. In these implementations, providing the prompt to the LLM includes providing the prompt that includes the one or more particular categories.

In some implementations, generating the user interface includes identifying a subset of facets that match a user profile or a user context, and generating the one or more user interface elements, each user interface element corresponding to a respective facet of the subset of facets.

Some implementations include a non-transitory computer readable medium with instructions stored thereon that, when executed by one or more processors, cause the one or more processors to perform operations that include obtaining a plurality of items of user-generated content, wherein each item of the user-generated content includes at least one of text, image, audio, video, or combinations thereof, and wherein each item of the user-generated content is associated with an entity. The operations further include providing a prompt to a large language model (LLM) to analyze the plurality of items to generate a plurality of facets. The operations further include generating a user interface that includes information about the entity and one or more user interface elements, each user interface element corresponding to a respective facet of the plurality of facets. The operations further include receiving user selection of a particular user interface element of the one or more user interface elements. The operations further include, responsive to the user selection of the particular user interface element, updating the user interface to display one or more items of the plurality of items of user-generated content that are associated with the facet corresponding to the particular user interface element.

In some implementations, the operations further include pruning the plurality of facets.

In some implementations, each facet of the plurality of facets is associated with a respective category, and the operations further include storing the category associated with the facet corresponding to the particular user element in a database. In some implementations, the operations further include identifying one or more particular categories that meet a user selection threshold. In these implementations, providing the prompt to the LLM includes providing the prompt that includes the one or more particular categories.

In some implementations, generating the user interface includes identifying a subset of facets that match a user profile or a user context; and generating the one or more user interface elements, each user interface element corresponding to a respective facet of the subset of facets.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 illustrates an example website with conventional sort options, in accordance with some implementations described herein.

FIG. 2 illustrates another example website with options to search and filter user-generated content, in accordance with some implementations described herein.

FIG. 3 is a block diagram of an example network environment which may be used for one or more implementations described herein.

FIG. 4 is a flow diagram illustrating an example method to automatically generate and display facets, according to some implementations.

FIGS. 5A and 5B illustrate an example of user-generated content (UGC) being transformed into a facet using the techniques described herein.

FIG. 6 illustrates the use of context and active learning to inform facet generation, in accordance with some implementations described herein.

FIG. 7 illustrates a user interface that includes facets automatically generated from user-generated content, in accordance with some implementations described herein.

FIG. 8 is a block diagram of an example device which may be used for one or more implementations described herein., in accordance with some implementations described herein.

### DETAILED DESCRIPTION

Techniques are described herein to automatically generate facets from unstructured data, e.g., user-generated content (UGC) including text, images, audio, video, or combinations thereof. A large language model is trained and utilized to analyze UGC to automatically identify facets.

In particular, a prompt is provided to a large language model (LLM) requesting the LLM to generate facets. The prompt may instruct the LLM to analyze UGC and identify questions that the UGC is responsive to, or semantic concepts that are included in the UGC. The questions and/or semantic concepts may be utilized to automatically generate facets, e.g., short snippets of text corresponding to the concept. In generating the facets, the LLM may be provided contextual information, e.g., semantic concepts of interest, semantic concepts to exclude, contextual information obtained with user permission, etc.

The techniques leverage the capability of large language models to distill knowledge representations and identify facets from any kind of data, including unstructured text and other types of UGC. Since trained LLMs can perform extraction of such facets from any data, the described techniques can automatically generate facets from any set of information, e.g., UGC such as entity reviews (place reviews, or other reviews), blogs or other text writing, audio such as podcasts, video, etc. The techniques can cover a much wider set of concepts than conventional facets based on structured data as well as facets based on keywords. Filters based on the generated facets can be provided in a user interface to enable users to filter information based on particular criteria of their choice. The techniques thus reduce computational burden incurred when users are unable to find information of their interest, causing increased usage of screen time, processor, and memory resources to browse or view information. The techniques solve a technical problem of generating facets automatically from structured as well as unstructured data without limitation of domain. Further, the techniques can use a pre-trained LLM to automatically generate facets, without needing to expend computer resources to train specific machine learning models for this purpose.

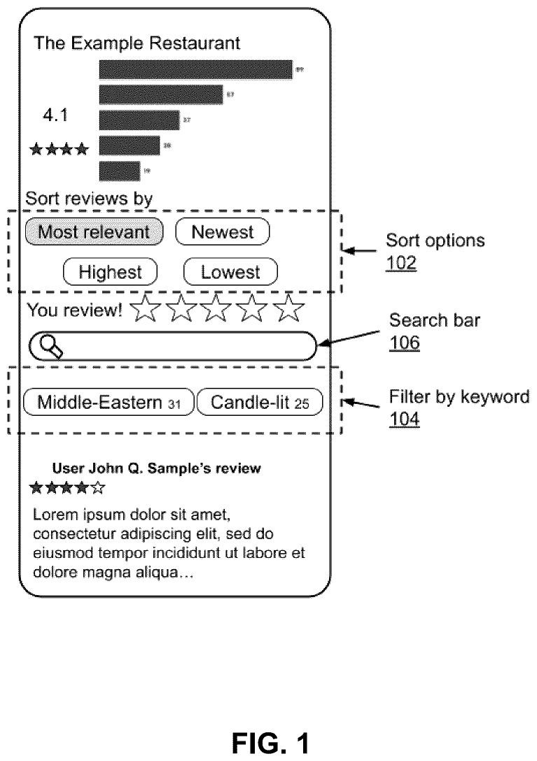

FIG. 1 illustrates an example website with conventional sort options, in accordance with some implementations described herein. In the example of FIG. 1, the website is a restaurant review website where users can provide reviews, e.g., star ratings along a scale (e.g., 1 being lowest and 5 being highest) as well as text content. In the example of FIG. 1, the reviews of the establishment (“The Example Restaurant”) can be sorted using various sort options 102. For example, the sort options include top-rated, most relevant, newest, highest-ranked, lowest-ranked, etc. Reviews can also be filtered by facets (104) such as “Middle-Eastern,” “Candle-lit” which can be obtained from the text content of reviews using relatively simple techniques, e.g., word frequency. In the example of FIG. 1, the numbers “31” and “25” adjacent to “Middle-Eastern” and “Candle-lit” indicate the number of reviews that match the facet. Search bar 106 is also included and enables users to perform free-text searches within reviews.

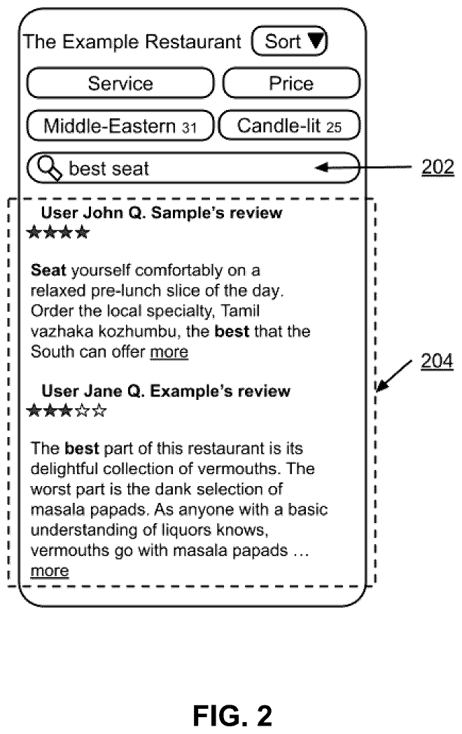

FIG. 2 illustrates another example website with conventional options to search and filter user-generated content, in accordance with some implementations described herein. In the example of FIG. 1, the website is a restaurant review website where users can provide reviews, e.g., star ratings along a scale (e.g., 1 being lowest and 5 being highest) as well as text content. As illustrated in FIG. 2, searching and filtering reviews can be monolithic, e.g., with a standard keyword (e.g., “service,” “price,” etc.) or sorting-option set and with a limited number of facets (e.g., “middle-eastern,” “candle-lit,”) of limited relevance. In the example of FIG. 2, the numbers “31” and “25” adjacent to “Middle-Eastern” and “Candle-lit” indicate the number of reviews that match the facet. In particular, free-text search (202, ‘best seat’) via the search box can result in less-than-satisfactory search results (204). On current review websites, searching through reviews is cumbersome. It is difficult to add contextual queries about a place or an establishment. Users are effectively limited to pre-defined facets and free-text searches using the search box which often produce unsatisfactory results.

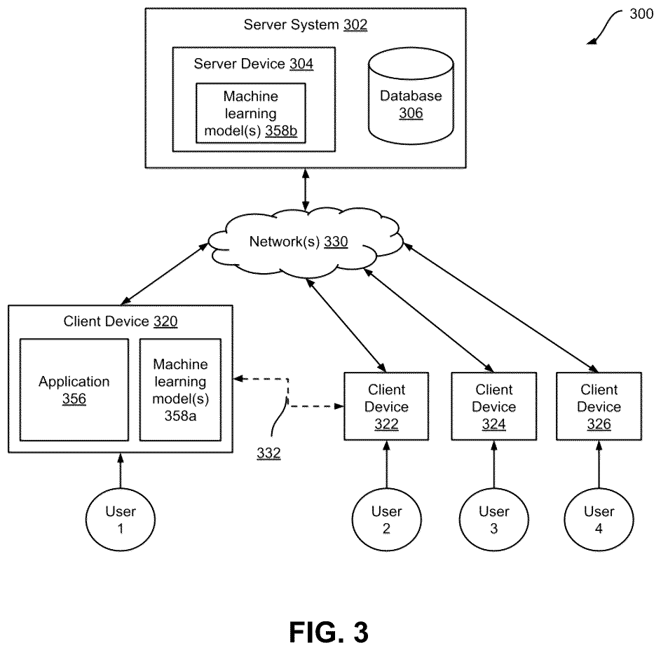

FIG. 3 illustrates a block diagram of an example network environment 300, which may be used in some implementations described herein. In some implementations, network environment 300 includes one or more server systems, e.g., server system 302 in the example of FIG. 3 Server system 302 can communicate with a network 330, for example. Server system 302 can include a server device 304 and a database 306 or other storage device. In some implementations, server device 304 may provide one or more machine learning models 358b, one or more large language models or any type of generative artificial intelligence (generative AI) model. In FIG. 3 and the remaining figures, a letter after a reference number, e.g., “358a,” represents a reference to the element having that particular reference number. A reference number in the text without a following letter, e.g., “356,” represents a general reference to embodiments of the element bearing that reference number.

Network environment 300 also can include one or more client devices, e.g., client devices 320, 322, 324, and 326, which may communicate with each other and/or with server system 302 via network 330. Network 330 can be any type of communication network, including one or more of the Internet, local area networks (LAN), wireless networks, switch or hub connections, etc. In some implementations, network 330 can include peer-to-peer communication between devices, e.g., using peer-to-peer wireless protocols (e.g., Bluetooth®, Wi-Fi Direct, etc.), etc. One example of peer-to-peer communications between two client devices 320 and 322 is shown by arrow 332.

For ease of illustration, FIG. 3 shows one block for server system 302, server device 304, database 306, and four blocks for client devices 320, 322, 324, and 326. Blocks 302, 304, and 306 may represent multiple systems, server devices, and network databases, and the blocks can be provided in different configurations than shown. For example, server system 302 can represent multiple server systems that can communicate with other server systems via the network 330. In some implementations, server system 302 can include cloud hosting servers, for example. In some examples, database 306 and/or other storage devices can be provided in server system block(s) that are separate from server device 304 and can communicate with server device 304 and other server systems via network 330.

Also, there may be any number of client devices. Each client device can be any type of electronic device, e.g., desktop computer, laptop computer, portable or mobile device, cell phone, smartphone, tablet computer, television, TV set top box or entertainment device, wearable devices (e.g., display glasses or goggles, wristwatch, headset, armband, jewelry, etc.), personal digital assistant (PDA), media player, game device, etc. Some client devices may also have a local database similar to database 306 or other storage. In some implementations, network environment 300 may not have all of the components shown and/or may have other elements including other types of elements instead of, or in addition to, those described herein.

In various implementations, end-users User1, User2, User3, and User4 may communicate with server system 302 and/or each other using respective client devices 320, 322, 324, and 326. In some examples, users User1, User2, User3, and User4 may interact with each other via applications running on respective client devices and/or server system 302 and/or via a network service, e.g., a social network service or other type of network service, implemented on server system 302. For example, respective client devices 320, 322, 324, and 326 may communicate data to and from one or more server systems, e.g., server system 302.

In some implementations, the server system 302 may provide appropriate data to the client devices such that each client device can receive communicated content or shared content uploaded to the server system 302 and/or a network service. In some examples, users User1-User4 can interact via audio or video conferencing, audio, video, or text chat, or other communication modes or applications.

A network service implemented by server system 302 can include a system allowing users to perform a variety of communications, form links and associations, upload and post shared content such as images (e.g., individual images, image collections such as image albums, view user-generated content, e.g., restaurant reviews, etc. For example, a client device can display received data such as UGC sent or streamed to the client device and originating from a different client device via a server and/or network service (or from the different client device directly) or originating from a server system and/or network service. In some implementations, client devices can communicate directly with each other, e.g., using peer-to-peer communications between client devices as described above. In some implementations, a “user” can include one or more programs or virtual entities, as well as persons that interface with the system or network.

In some implementations, any of client devices 320, 322, 324, and/or 326 can provide one or more applications. For example, as shown in FIG. 3, client device 320 may provide application 356, e.g., a digital map application, a restaurant aggregator application, or any other application. Client device 320 may also include one or more machine learning models 358a. For example, model 358a may be a large language model configured for use on client devices. Client devices 322-326 may also provide similar applications.

Application 356 may be implemented using hardware and/or software of client device 320. In different implementations, application 356 may be a standalone client application, e.g., executed on any of client devices 320-326, or may work in conjunction with applications provided on server system 302.

In some implementations, client device 320 and/or client devices 322-326 may include one or more machine learning models 358. A client machine learning model 358a may be implemented using hardware and/or software of client device 320. In various implementations, machine learning model 358a may be usable directly on any of client devices 320-326, or may work in conjunction with machine learning model 358b provided on server system 302.

Machine learning (ML) model 358 may provide various functions. For example, ML model 358 may include a large language model (LLM) that can receive prompts as input (e.g., text prompts including commands to generate facets and other information such as context and parameters for the command, or characteristics of output responses provided by the LLM). For example, such functions may include automatically generating facets from user-generated content in response to a received prompt.

In some implementations, the language model may be a machine learning model that is capable of generating short text snippets in response to text prompts provided as input to the model. In some implementations, the text prompts may include a task description for a task, parameters for the task, contextual inputs, etc. and the language model may generate output text. In some implementations, the language model may provide an application programming interface (API) for other applications, e.g., to enable the other application such as application 356 to utilize the language model to generate text by providing a prompt. Language model 358 may utilize data, e.g., images, image metadata including image labels, audio, video, text (user-generated content and/or other content, data from a user account (e.g., a user profile of a user associated with a client device 320), etc. The data may be stored locally on client device 320, and/or may be retrieved from server device 304. In some implementations, the language model may be a multimodal model, e.g., that can take as input non-text data such as text, images, audio, videos, binary files, or other types of data.

In different implementations, client device 320 and/or server device 304 may provide other applications (not shown) that may be applications that provide various types of functionality, e.g., calendar, address book, e-mail, web browser, shopping, transportation (e.g., taxi, train, airline reservations, etc.), entertainment (e.g., a music player, a video player, a gaming application, etc.), social networking (e.g., messaging or chat, audio/video calling, sharing images/video, etc.) and so on. In some implementations, one or more of other applications may be standalone applications that execute on client device 320. In some implementations, one or more of other applications may access a server system, e.g., server system 302, that provides data and/or functionality of other applications. In various implementations, data associated with the one or more other applications may be stored in a user account. With user permission, the data of the user account may be provided to machine learning models 358.

A user interface on a client device 320, 322, 324, and/or 326 can enable the display of user content and other content, including user-generated context such as entity reviews or other content associated with various entities, images, image albums, video, data, and other content as well as communications, privacy settings, notifications, and other data. Such a user interface can be displayed using software on the client device, software on the server device, and/or a combination of client software and server software executing on server device 304, e.g., application software or client software in communication with server system 302. The user interface can be displayed by a display device of a client device or server device, e.g., a touchscreen or other display screen, projector, etc. In some implementations, application programs running on a server system can communicate with a client device to receive user input at the client device and to output data such as visual data, audio data, etc. at the client device.

Other implementations of features described herein can use any type of system and/or service. For example, other networked services (e.g., connected to the Internet) can be used instead of or in addition to a social networking service. Any type of electronic device can make use of features described herein. Some implementations can provide one or more features described herein on one or more client or server devices disconnected from or intermittently connected to computer networks. In some examples, a client device including or connected to a display device can display content posts stored on storage devices local to the client device, e.g., received previously over communication networks.

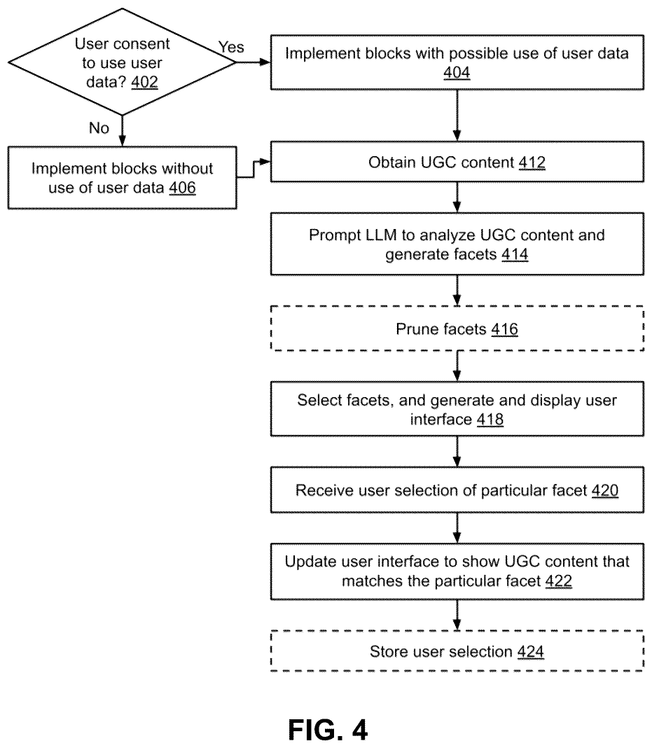

FIG. 4 is a flow diagram illustrating an example method 400 to automatically generate and display facets, according to some implementations. In some implementations, method 400 can be implemented, for example, on a server system 302 as shown in FIG. 3. In some implementations, some or all of the method 400 can be implemented on one or more client devices 320, 322, 324, or 326 as shown in FIG. 3, one or more server devices, and/or on both server device(s) and client device(s). In described examples, the implementing system includes one or more digital processors or processing circuitry (“processors”), and one or more storage devices (e.g., a database 306 or other storage). In some implementations, different components of one or more servers and/or clients can perform different blocks or other parts of the method 400. In some examples, a first device is described as performing blocks of method 400. Some implementations can have one or more blocks of method 400 performed by one or more other devices (e.g., other client devices or server devices) that can send results or data to the first device.

In some implementations, the method 400, or portions of the method, can be initiated automatically by a system. In some implementations, the implementing system is a first device. For example, the method (or portions thereof) can be periodically performed, or performed based on one or more particular events or conditions, e.g., a user request, a predetermined time period having expired since the last performance of method 400, and/or one or more other conditions occurring which can be specified in settings read by the method.

Method 400 may begin at block 402. In block 402, it is checked whether user consent (e.g., user permission) has been obtained to use user data in the implementation of method 400. For example, user data may include a user's preferences regarding places (e.g., restaurants, stadiums, concert halls, event venues, etc.), a user's current location and/or historical locations, account information of a user's account with an online service (e.g., a user profile), user data related to the use of a place review application, user preferences, etc. One or more blocks of the methods described herein may use such user data in some implementations.

If user consent has been obtained from the relevant users for which user data may be used in the method 400, then in block 404, it is determined that the blocks of the methods herein can be implemented with possible use of user data as described for those blocks, and the method continues to block 412. If user consent has not been obtained, it is determined in block 406 that blocks are to be implemented without the use of user data, and the method continues to block 412. In some implementations, if user consent has not been obtained, blocks are implemented without the use of user data and with synthetic data and/or generic or publicly-accessible and publicly-usable data. In some implementations, if user consent has not been obtained, remaining blocks of method 400 are not performed.

At block 412, a plurality of items of user-generated content (UGC) are obtained. In various implementations items of the user-generated content may include text, image, audio, video, or any combination thereof. Each item of the user-generated content is associated with an entity. For example, an item of UGC may be a review of a physical location (e.g., restaurant review, store review, review of a performance venue such as a concert hall or stadium), an entity review (e.g., a movie review, a book review), an event review (e.g., a review of a concert or play), etc.

In some implementations, items of UGC may include user-provided text, image(s), audio, video, or any combination thereof. For example, a digital map service may include a plurality of entities, e.g., places, and may enable users to provide content items, e.g., reviews for the entity. In another example, a restaurant aggregator service or restaurant database, an events booking service, or other online services/applications may enable users to provide content items for the entities in their database. For example, users may contribute restaurant reviews that review a restaurant entity on various factors such as food quality, food variety, ambience (e.g., visual appeal, audio environment, whether noisy or quiet, etc.), location, parking facilities, seating comfort, suitability for particular types of events, etc. Similarly, users may contribute content items for any entity. Block 412 may be followed by block 414.

At block 414, a prompt is provided to a large language model (LLM) to analyze the plurality of items of the UGC to generate a plurality of facets. In some implementations, e.g., when the content items include multiple modalities (e.g., two or more of text, image, audio, video), the LLM may be a multi-modal LLM. In some implementations, e.g., when the content items are of a single modality (e.g., text only), the LLM may be a text-only LLM.

For example, the prompt may provide an individual content item and a command to the LLM to generate facets from the content item. For example, a facet may include short phrases or other content (e.g., thumbnail images, short videos, audio snippets, etc.) that indicate concepts that the content item relates to (e.g., questions to which that content item includes answers). In some implementations, the prompt may specify a limit for size of the facet, e.g., the short phrases or other content (e.g., less 20 characters for text, 3 seconds for audio/video, 200×200 pixels for image), etc. In some implementations, the prompt may include information about the entity type and/or information associated with the entity (e.g., name, address, operating hours, etc. for a restaurant or other place). In some implementations, e.g., if the entity is a larger entity within which smaller entities exist (e.g., a mall with several stores and restaurants), and the UGC includes content associated with either or both, a single UGC item may be mined to generate facets for multiple entities by prompting the LLM with the target entity for which the facets are to be generated.

For example, consider that the content item is a restaurant review with the following text: “This place serves only vegan food, no dairy or meat whatsoever. Due to commuter crowd, there's no parking on weekdays but weekends are free. Tip: block your table in advance.” The prompt provided to the LLM indicates that facets are to be less than 20 characters. In response to the prompt, the LLM may generate the facets “vegan only”, “good for weekend”, “takes reservations” based on analyzing the text. For example, since the text includes “serves only vegan food, no dairy or meat whatsoever” the LLM generates “vegan only” as a facet, indicating that the restaurant serves vegan food. Similarly, since the text includes “block your table in advance” the LLM generates “takes reservations” as a facet.

In some implementations, the prompt may include further commands for the LLM, e.g., “generate questions to which this content item is an answer; then, compress the questions to short phrases of less than twenty characters.” In some implementations, generated facets may be associated with categories. For example, for a restaurant, the facets “accessible restroom,” “accessible stairway,” “child seat,” etc. may all be associated with the category “accessibility” while the facets “great drinks,” “rock music,” “large screen TV,” may be associated with “party-friendly.”

In some implementations, providing the prompt to the LLM may include providing a prompt that includes the one or more particular categories. For example, facets may be associated with different categories and the LLM may be prompted to include or exclude certain categories. For example, in the case of a restaurant review, facets that may be generated by the LLM that are the same as (similar to) pre-defined facets (e.g., “cuisine,” “price,”) etc. are excluded from the results provided by the LLM when such a prompt is included. In another example, facets unrelated to the entity type (e.g., “nice weather” for an indoor restaurant) may be excluded based on such a prompt. In another example, categories associated with a restaurant that correspond to popular facets (e.g., previously selected by users) such as “noise level,” “custom menu every day,” “pet-friendly,” “accessible restroom,”) etc. may be included based on the prompt. In some implementations, the prompt may provide a higher level of trust and safety in the generated facets, e.g., by automatically excluding categories unsuitable for surfacing as facets. Block 414 may be followed by block 416.

At block 416, facets generated by the LLM are pruned. In some implementations, facets generated by the LLM may be ranked and pruned. For example, if an LLM generates a large number of facets for a restaurant that has hundreds of reviews, facets that are not typically selected by users may be ranked lower and pruned (e.g., removed from a set of facets eligible for surfacing to users). For example, if some restaurant reviews mention the floor type (e.g., “carpet”) and floor type is not a popular category for the entity type restaurant, the facet may be pruned. In some implementations, facets associated with less than a threshold number of content items may be pruned to ensure reliability. In some implementations, block 416 may not be performed. Block 416 may be followed by block 418.

At block 418, a user interface is generated that includes information about the entity and one or more user interface elements, each user interface element corresponding to a respective facet of the plurality of facets. For example, the user interface element may include text generated by the LLM for the facet. The user interface elements are selectable by the user.

In some implementations, generating the user interface may include identifying a subset of facets that match a user profile or a user context. For example, if the user profile indicates that the user is vegan, facets related to vegan choices (e.g., “vegan only,” “plant-based cheese,” “no dairy,”) may be selected for presentation to the user. In another example, if the user context (e.g., the user's calendar) indicates that the user is in a hurry, facets related to service time (e.g., “quick service,”) may be selected for presentation. In these implementations, accessing the user profile and/or user context is performed with specific user permission and for the purpose of facet selection. Users are provided options to turn off such personalization. In various implementations, selection of facets may be performed based on collaborative filtering (e.g., where user profiles are matched against facets), machine learning techniques (e.g., where embeddings or feature vectors of user profiles are matched against embeddings of facets associated with an entity), or any other suitable technique. In some implementations, no personalization may be done. In some implementations, facet selection may be based on overall context, e.g., time of day (e.g., facets related to dinner at a restaurant), day of the week (e.g., facets related to weekdays vs. weekends), holiday (e.g., facets related to particular days), or any other non-user-specific contextual factors. The user interface elements that are generated may each correspond to a respective facet of the subset of facets. Block 418 may be followed by block 420.

At block 420, user selection of a particular user interface element is received. In various implementations, the user may provide their selection via touch or gesture input, via input device such as a mouse, keyboard, trackpad, etc., via audio, or any other suitable mechanism. Block 420 may be followed by block 422.

At block 422, the user interface is updated to display one or more items of the plurality of items of user-generated content that are associated with the facet corresponding to the particular user interface element. For example, content items are restaurant reviews, and the user selects a facet related to “noise level,” reviews that match the facet are identified and the user interface is updated to display the identified reviews. In some implementations, to enable identification of content items that match a selected facet, the LLM output may include, for each generated facet, identifiers associated with matching reviews. Providing the reviews that are associated with the facet can enable users to easily view details associated with that facet and verify that the information is accurate (e.g., multiple reviews indicate that the restaurant is “vegan only”). Block 422 may be followed by block 424.

At block 424, the category associated with the facet corresponding to the particular user element (selected by the user) is stored in a database, with user permission. For example, such storage may only store the fact that the facet was selected during user interaction, without storing any other user data. Storage of such data may enable ranking of facets based on popularity and may be useful during facet pruning, or for inclusion in prompts to the LLM, as described above. In some implementations, one or more particular categories that meet a user selection threshold are identified based on the database (e.g., facets that get selected at least 5% of the time they are displayed, facets that were selected at least 1,000 times, etc.). One or more of the identified categories may be provided in the prompt to the LLM to guide generation of facets that are likely of user interest.

Various blocks of method 400 may be combined, split into multiple blocks, or be performed in parallel. For example, blocks 416 and 424 may not be performed in some implementations. In some implementations, blocks 412-416 may be performed periodically to generate and prune facets, and blocks 418-424 may be performed when a user requests to view user-generated content about an entity, e.g., when displaying a webpage associated with a restaurant or other entity.

While the foregoing description refers to text facets, in various implementations, text, image, audio, video, or a combination of two or more of these may be identified as facets. For example, when viewing an image library, a particular entity (e.g., “girl riding a pony,” “yellow house with red roof titles,” etc.) identified by the LLM may be surfaced as a facet to enable the user to filter the content to view matching images. Similarly, video content may be analyzed to provide video facets, e.g., thumbnails that indicate concepts in the video.

In various implementations, a suitable large language model—text-only, or multimodal model may be utilized to automatically generate facets. While the foregoing description refers to reviews, any content such as blogs, books, podcasts, videos, etc. may be subjected to analysis by the LLM for automatic generation of facets for presentation in a user interface. In various implementations, the LLM may be fine-tuned to the facet generation task, e.g., by providing training examples of content and corresponding groundtruth facets, by providing facet categories that are associated with user satisfaction/dissatisfaction, etc. In some implementations, the LLM may be trained using a training corpus based on human annotated UGC and corresponding facets.

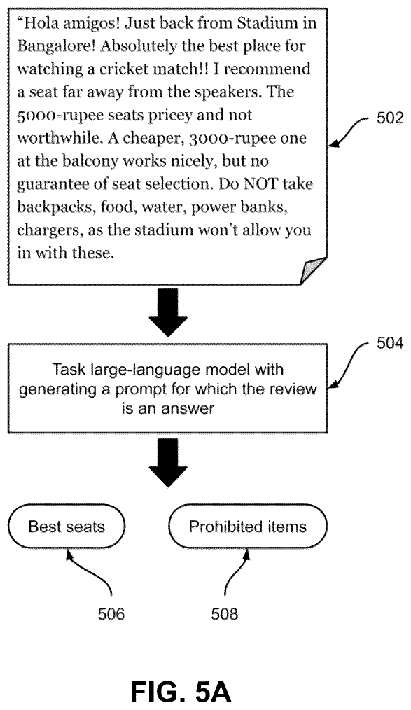

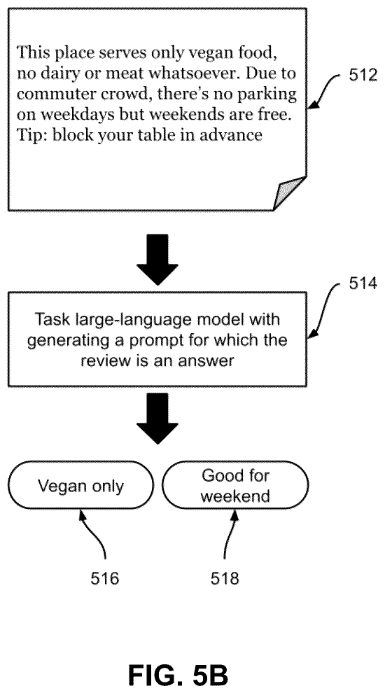

FIGS. 5A and 5B each illustrate an example of user-generated content (UGC) (e.g., user-provided text reviews) being transformed into a facet using the techniques described herein. In the example of FIG. 5A, the user-generated content 502 includes a user-provided review of a stadium. The review includes information provided by the authoring user regarding seats at the stadium and about restrictions on items that can be carried inside the stadium. A large language model (LLM) is tasked 504 with generating a prompt for which the review is the answer. In response to the task, the LLM generates corresponding facets 506 and 508.

The user-generated content 502 (user provided review of “Stadium in Bangalore”) includes the text portions “I recommend a seat far away from the speakers”; “The 5000-rupee seats are pricey and not worthwhile”; and “A cheaper, 3000-rupee one at the balcony works nicely, but no guarantee of seat selection.” These portions indicate that the review includes information regarding seats, e.g., quality, pricing, etc. There is also additional text (“Do NOT take backpacks, food, water, power banks, chargers, as the stadium won't allow you in with these.”) that indicates that the review includes information regarding items that are prohibited in the stadium.

In response to the task 504, the LLM produces facets 506 (“Best seats”) and 508 (“Prohibited items”). As can be seen in FIG. 5A, the facets are based on the user-generated content and are dynamically created from the UGC.

In the example of FIG. 5B, the user-generated content 512 includes details on food served at a restaurant, parking-related information and availability information. A large language model (LLM) is tasked 514 with generating a prompt for which the review is the answer. In response to the task, the LLM generates corresponding facets 516 and 518.

The user-generated content 512 includes the text portion “This place serves only vegan food, no dairy or meat whatsoever.” This portion indicates that the review includes information indicating that the restaurant being reviewed is vegan only. There is also additional text (“there's no parking on weekdays but weekends are free”) in the review that indicates that the review includes information regarding whether the restaurant is suitable for dining on the weekend.

In response to task 514, the LLM produces facets 516 (“Vegan only”) and 518 (“Good for weekend”).

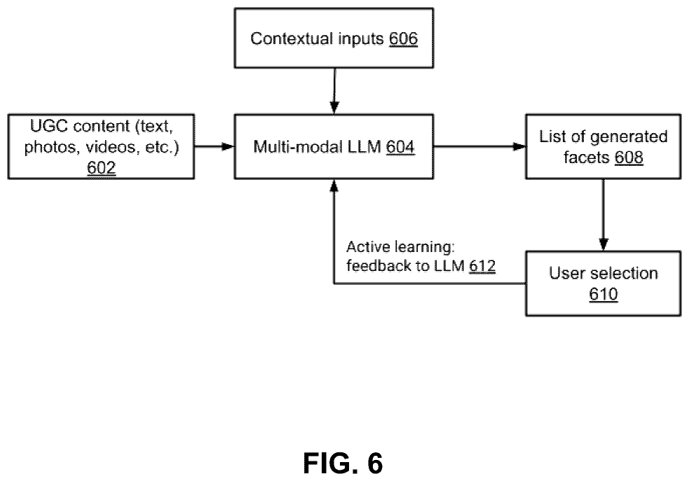

FIG. 6 is an example diagram illustrating the use of context and active learning to inform facet generation, according to some embodiments. User-generated content (602) which include text, photos, videos, etc. is fed to a multi-modal LLM (604) along with contextual inputs (606). For example, the contextual inputs can include information obtained from a knowledge repository. For example, if the UGC refers to a place, the information can include information about the place such as the place type, merchant information, business hours, features, and geography of the place; facts and events associated with the place; etc.

Facets are generated (608) and displayed by a large language model, as described above with reference to FIGS. 3-4. User selection of particular facets (610) is, with user permission, provided as feedback (612) to the LLM. The feedback serves as a form of active learning to improve facet generation. Such feedback can be effective to train the LLM to generate facets that are likely useful to users and/or suppress generated facets that are ignored by the users. For example, facets that are selected less than a threshold count (e.g., less than 5 times) or less than a threshold proportion (e.g., less than 10% of the times the facet is displayed) can be determined as being ignored by users.

The techniques described herein reverse the traditional mode of operation of an LLM, which is to train the LLM to generate content given prompts as input. In contrast, the LLM described herein is trained with user-generated content (e.g., a set of reviews of an entity) to generate prompts for the content. Entity information, e.g., the type of place, location information, contextual information relating to the place (typical happenings, food choices, things to carry, etc.), are blended into the training. The LLM can be a general-purpose LLM or a custom/bespoke LLM optimized with geographical context. In this manner, LLMs are leveraged effectively in reverse, to generate facets that are queries, based on known responses (e.g., corresponding UGC reviews). In various implementations, human raters may evaluate the generated output facets. Over time, facet selections as performed by users can be used (with user permission) to fine-tune the LLM. Since the LLM can identify facets based on content in a review and interpreting the meaning, the generated facets may be different from and superior to those identified by traditional techniques of automatically generating facets, e.g., naive selection (e.g., based on word frequency) of keywords. Effectively, generative artificial intelligence is leveraged to automatically create facets from content.

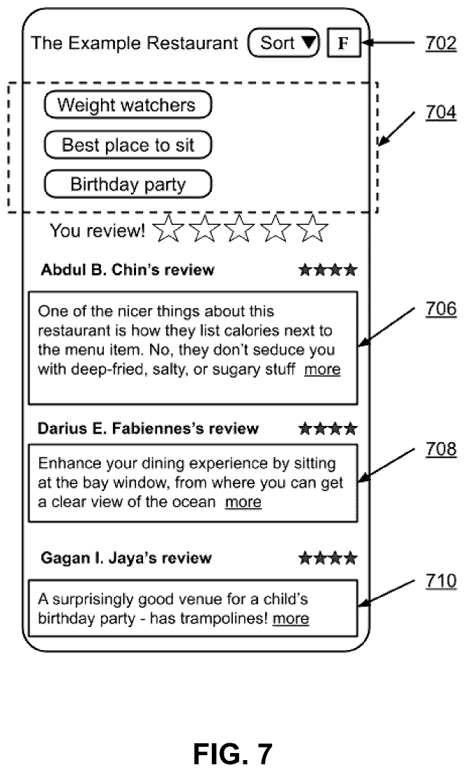

FIG. 7 illustrates a user interface that includes facets automatically generated from user-generated content, in accordance with some embodiments. In the example of FIG. 7, the user interface is of a website or application that provides access to place information, e.g., restaurant information including restaurant reviews.

In the example of FIG. 7, reviews from three users are illustrated, each with a respective star rating for the place and user-generated content (text) of the review. While FIG. 7 shows text reviews, in various embodiments, the reviews may include images, videos, etc.

Facets generated automatically using the techniques described herein are shown as suggestions in the user interface to enable filtering of reviews. In the example of FIG. 7, a facet icon (702) is displayed to enable the user to access automatically generated facets. For example, upon user selection of the facet icon, automatically generated facets (704) are displayed. User-generated content, e.g., place reviews that include text, images, video, etc. are filtered based on the facet selected by the user and displayed.

As illustrated in FIG. 7, facets (704) enable users to quickly filter to specific types of place information. The facets incorporate contextual information about a place, place type, place ratings, reviews voted by users as useful, etc. In the example of FIG. 7, the facets (704) include “Weight watchers” “Best place to sit” and “Birthday party.” In some implementations, the user-generated content (e.g., reviews displayed in the user interface) is automatically filtered to match the facets (704). In the example of FIG. 7, review 706 includes information regarding food served at the restaurant being suitable for weight watchers, e.g., “list calories” “don't seduce you with deep-fried, salty, or sugary stuff,” matching the “weight watchers” facet. Similarly, review 708 includes content that is responsive to the “best place to sit” facet and review 710 includes content responsive to the “birthday party” facet.

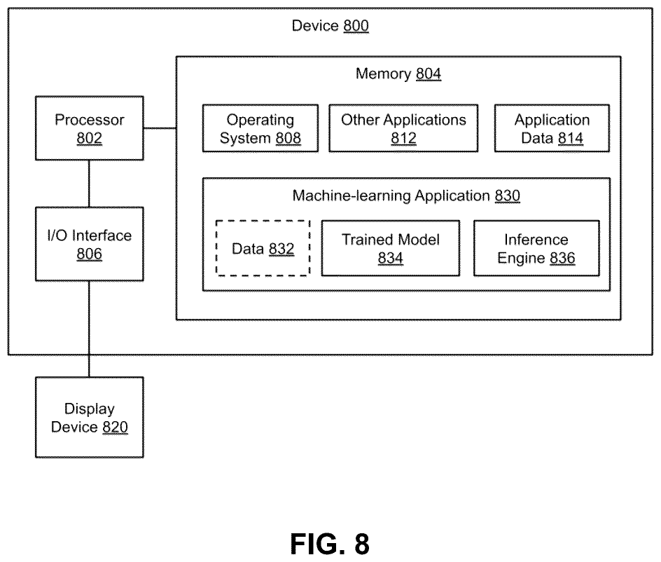

FIG. 8 is a block diagram of an example device 800 which may be used to implement one or more features described herein. In one example, device 800 may be used to implement a client device, e.g., any of client devices 320-326 shown in FIG. 3. Alternatively, device 800 can implement a server device, e.g., server 304. In some implementations, device 800 may be used to implement a client device, a server device, or both client and server devices. Device 800 can be any suitable computer system, server, or other electronic or hardware device as described above.

One or more methods described herein can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 800 includes a processor 802, a memory 804, and input/output (I/O) interface 806. Processor 802 can be one or more processors and/or processing circuits to execute program code and control basic operations of the device 800. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some implementations, processor 802 may include one or more co-processors that implement neural-network processing. In some implementations, processor 802 may be a processor that processes data to produce probabilistic output, e.g., the output produced by processor 802 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 804 is typically provided in device 800 for access by the processor 802 and may be any suitable processor-readable storage medium, such as random access memory (RAM), read-only memory (ROM), Electrical Erasable Read-only Memory (EEPROM), Flash memory, etc., suitable for storing instructions for execution by the processor, and located separate from processor 802 and/or integrated therewith. Memory 804 can store software operating on the server device 800 by the processor 802, including an operating system 808, machine-learning application 830, other applications 812, and application data 814. Other applications 812 may include applications such as a data display engine, web hosting engine, image display engine, notification engine, social networking engine, etc. In some implementations, the machine-learning application 830 and other applications 812 can each include instructions that enable processor 802 to perform functions described herein, e.g., some or all of the method of FIG. 4.

Other applications 812 can include, e.g., digital map applications, place database applications (e.g., restaurant, event venue, or other types of place databases), media display applications, communication applications, web hosting engines or applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 834 may utilize Bayesian classifiers, support vector machines, neural networks, or other learning techniques. In some implementations, machine-learning application 830 may include a trained model 834 (e.g., a large language model, or any type of generative artificial intelligence), an inference engine 836, and data 832. In some implementations, data 832 may include training data, e.g., data used to generate trained model 834. For example, training data may include any type of data such as text, images, audio, video, etc.

In some implementations, trained model 834 may be a large language model. The large language model may include a large number of parameters (e.g., thousands, millions, or billions of parameters). The large language model may be trained to respond to prompts with natural language text. The large language model may be trained based on a large corpus of text. In some implementations, the corpus of text used to train the large language model may include user-generated content such as text content (e.g., reviews or user comments about various entities), images and image descriptions (e.g., photos of places), image titles, emojis associated with images, social media posts or other user-generated content that includes one or more of text, audio, images, and/or videos, etc.

Training data may be obtained from any source, e.g., a data repository specifically marked for training, data for which permission is provided for use as training data for machine-learning, etc. In implementations where one or more users permit use of their respective user data to train a machine-learning model, e.g., trained model 834, training data may include such user data. In implementations where users permit use of their respective user data, data 832 may include permitted data such as text or other types of data images (e.g., user-provided entity reviews, photos, videos, or other user-generated content).

In some implementations, training data may include synthetic data generated for the purpose of training, such as data that is not based on user input or activity in the context that is being trained, e.g., data generated from simulated photographs or other computer-generated images. In some implementations, machine-learning application 830 excludes data 832. For example, in these implementations, the trained model 834 may be generated, e.g., on a different device, and be provided as part of machine-learning application 830. In various implementations, the trained model 834 may be provided as a data file that includes a model structure or form, and associated weights. Inference engine 836 may read the data file for trained model 834 and implement a neural network with node connectivity, layers, and weights based on the model structure or form specified in trained model 834.

In some implementations, the trained model 834 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc. The model form or structure may specify connectivity between various nodes and organization of nodes into layers.

For example, the nodes of a first layer (e.g., input layer) may receive data as input data 832 or application data 814. For example, when trained model 834 is a large language model, the input data may include a prompt (e.g., textual prompt). Subsequent intermediate layers may receive as input output of nodes of a previous layer per the connectivity specified in the model form or structure. These layers may also be referred to as hidden layers or latent layers.

A final layer (e.g., output layer) produces an output of the machine-learning application. For example, the output may be generated text, e.g., facets (or short snippets of text). In some implementations, model form or structure also specifies a number and/or type of nodes in each layer.

In different implementations, trained model 834 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 834 may include weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 832, to produce a result.

For example, training may include applying supervised learning techniques. In supervised learning, the training data can include a plurality of inputs (e.g., a set of UGC items) and a corresponding expected output for each input (e.g., a set of groundtruth facets corresponding to the set of UGC items). Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided and the model may be trained to differentiate data, e.g., to cluster input data into a plurality of groups, where each group includes input data that are similar in some manner.

In some implementations, unsupervised learning may be used to produce knowledge representations, e.g., that may be used by machine-learning application 830. For example, unsupervised learning may be used to produce embeddings that are utilized by machine-learning application 830. In various implementations, a trained model includes a set of weights, or embeddings, corresponding to the model structure. In implementations where data 832 is omitted, machine-learning application 830 may include trained model 834 that is based on prior training, e.g., by a developer of the machine-learning application 830, by a third-party, etc. In some implementations, trained model 834 may include a set of weights that are fixed, e.g., downloaded from a server that provides the weights.

Machine-learning application 830 also includes an inference engine 836. Inference engine 836 is configured to apply the trained model 834 to data, such as application data 814, to provide an inference. In some implementations, inference engine 836 may include software code to be executed by processor 802. In some implementations, inference engine 836 may specify circuit configuration (e.g., for a programmable processor, for a field programmable gate array (FPGA), etc.) enabling processor 802 to apply the trained model. In some implementations, inference engine 836 may include software instructions, hardware instructions, or a combination. In some implementations, inference engine 836 may offer an application programming interface (API) that can be used by operating system 808 and/or other applications 812 to invoke inference engine 836, e.g., to apply trained model 834 to application data 814 to generate an inference. For example, the inference for a LLM model may be generated text or other types of generated content.

Machine-learning application 830 may provide several technical advantages. For example, when trained model 834 is generated based on unsupervised learning, trained model 834 can be applied by inference engine 836 to produce knowledge representations (e.g., numeric representations) from input data, e.g., application data 814. For example, a model trained for image analysis may produce representations of images that have a smaller data size (e.g., 1 KB) than input images (e.g., 10 MB). In some implementations, such representations may be helpful to reduce processing cost (e.g., computational cost, memory usage, etc.) to generate an output (e.g., a label, a classification, generated text in response to a prompt including image metadata and task description, etc.).

In some implementations, such representations may be provided as input to a different machine-learning application that produces output from the output of inference engine 836. In some implementations, knowledge representations generated by machine-learning application 830 may be provided to a different device that conducts further processing, e.g., over a network. In such implementations, providing the knowledge representations rather than the images may provide a technical benefit, e.g., enable faster data transmission with reduced cost. In some implementations, the knowledge representations may be facets representative of key semantic concepts in the UGC items provided as input to the model. In another example, a model trained for clustering documents may produce document clusters from input documents. The document clusters may be suitable for further processing (e.g., determining whether a document is related to a topic, determining a classification category for the document, etc.) without the need to access the original document, and therefore, save computational cost.

In some implementations, machine-learning application 830 may be implemented in an offline manner. In these implementations, trained model 834 may be generated in a first stage and provided as part of machine-learning application 830. In some implementations, machine-learning application 830 may be implemented in an online manner. For example, in such implementations, an application that invokes machine-learning application 830 (e.g., operating system 808, one or more of other applications 812) may utilize an inference produced by machine-learning application 830, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 834, e.g., to update embeddings for trained model 834.

In some implementations, machine-learning application 830 may be implemented in a manner that can adapt to particular configuration of device 800 on which the machine-learning application 830 is executed. For example, machine-learning application 830 may determine a computational graph that utilizes available computational resources, e.g., processor 802. For example, if machine-learning application 830 is implemented as a distributed application on multiple devices, machine-learning application 830 may determine computations to be carried out on individual devices in a manner that optimizes computation. In another example, machine-learning application 830 may determine that processor 802 includes a GPU with a particular number of GPU cores (e.g., 1000) and implement the inference engine accordingly (e.g., as 1000 individual processes or threads).

In some implementations, machine-learning application 830 may implement an ensemble of trained models. For example, trained model 834 may include a plurality of trained models that are each applicable to the same input data. In these implementations, machine-learning application 830 may choose a particular trained model, e.g., based on available computational resources, success rate with prior inferences, etc. In some implementations, machine-learning application 830 may execute inference engine 836 such that a plurality of trained models is applied. In these implementations, machine-learning application 830 may combine outputs from applying individual models, e.g., using a voting-technique that scores individual outputs from applying each trained model, or by choosing one or more particular outputs. Further, in these implementations, the machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 808 or one or more applications 812.

In different implementations, machine-learning application 830 can produce different types of outputs. For example, machine-learning application 830 can provide representations or clusters (e.g., numeric representations of input data), labels (e.g., for input data that includes images, documents, etc.), phrases or sentences (e.g., representative of text content such as UGC including reviews, descriptive of an image or video, suitable for use as a facet, etc.), images (e.g., image thumbnails or schematic images representative of semantic concepts in UGC), audio or video, etc. In some implementations, machine-learning application 830 may produce an output based on a format (e.g., text of less than a specified length) specified by an invoking application, e.g., operating system 808 or one or more applications 812. In some implementations, an invoking application may be another machine-learning application. For example, such configurations may be used in generative adversarial networks, where an invoking machine-learning application is trained using output from machine-learning application 830 and vice-versa.

Any of software in memory 804 can alternatively or additionally be stored on any other suitable storage location or computer-readable medium. In addition, memory 804 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 804 and any other type of storage (magnetic disk, optical disk, magnetic tape, or other tangible media) can be considered “storage” or “storage devices.”

I/O interface 806 can provide functions to enable interfacing the server device 800 with other systems and devices. Interfaced devices can be included as part of the device 800 or can be separate and communicate with the device 800. For example, network communication devices, storage devices (e.g., memory and/or database 306), and input/output devices can communicate via I/O interface 806. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 806 can include one or more display devices 820 that can be used to display content, e.g., images, video, and/or a user interface of an output application as described herein. Display device 820 can be connected to device 800 via local connections (e.g., display bus) and/or via networked connections and can be any suitable display device. Display device 820 can include any suitable display device such as an LCD, LED, or plasma display screen, CRT, television, monitor, touchscreen, 3-D display screen, or other visual display device. For example, display device 820 can be a flat display screen provided on a mobile device, multiple display screens provided in a goggles or headset device, or a monitor screen for a computer device.

The I/O interface 806 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 8 shows one block for each of processor 802, memory 804, I/O interface 806, and software blocks 808, 812, and 830. These blocks may represent one or more processors or processing circuitries, operating systems, memories, I/O interfaces, applications, and/or software modules. In other implementations, device 800 may not have all of the components shown and/or may have other elements including other types of elements instead of, or in addition to, those shown herein. While some components are described as performing blocks and operations as described in some implementations herein, any suitable component or combination of components of environment 300, device 800, similar systems, or any suitable processor or processors associated with such a system, may perform the blocks and operations described.

Methods described herein can be implemented by computer program instructions or code, which can be executed on a computer. For example, the code can be implemented by one or more digital processors (e.g., microprocessors or other processing circuitry) and can be stored on a computer program product including a non-transitory computer readable medium (e.g., storage medium), such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and the operating system.

Although the description has been described with respect to particular implementations thereof, these particular implementations are merely illustrative, and not restrictive. Various concepts illustrated in the examples may be applied to other examples and implementations.

In situations in which certain implementations discussed herein may collect or use personal information about users (e.g., user data, information about a user's social network, user's location and time at the location, user's biometric information, user's activities and demographic information), users are provided with one or more opportunities to control whether information is collected, whether the personal information is stored, whether the personal information is used, and how the information is collected about the user, stored and used. That is, the systems and methods discussed herein collect, store and/or use user personal information specifically upon receiving explicit authorization from the relevant users to do so. For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user device's geographic location may be generalized to a larger region so that the user's particular location cannot be determined.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural, or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method, comprising:
obtaining a plurality of items of user-generated content, wherein each item of the user-generated content includes at least one of text, image, audio, video, or combinations thereof, and wherein each item of the user-generated content is associated with an entity;
providing a prompt to a large language model (LLM) to analyze the plurality of items to generate a plurality of facets;
generating a user interface that includes information about the entity and one or more user interface elements, each user interface element corresponding to a respective facet of the plurality of facets;
receiving user selection of a particular user interface element of the one or more user interface elements; and
in response to the user selection of the particular user interface element, updating the user interface to display one or more items of the plurality of items of user-generated content that are associated with the facet corresponding to the particular user interface element.

2. The computer-implemented method of claim 1, further comprising pruning the plurality of facets.

3. The computer-implemented method of claim 1, wherein each facet of the plurality of facets is associated with a respective category, and the method further comprises storing the category associated with the facet corresponding to the particular user element in a database.

4. The computer-implemented method of claim 3, further comprising identifying one or more particular categories that meet a user selection threshold, and wherein providing the prompt to the LLM includes providing the prompt that includes the one or more particular categories.

5. The computer-implemented method of claim 1, wherein generating the user interface comprises:
identifying a subset of facets that match a user profile or a user context; and
generating the one or more user interface elements, each user interface element corresponding to a respective facet of the subset of facets.

6. A computing device comprising:
a processor; and
a memory coupled to the processor, with instructions stored thereon that, when executed by the processor, cause the processor to perform operations comprising:
obtaining a plurality of items of user-generated content, wherein each item of the user-generated content includes at least one of text, image, audio, video, or combinations thereof, and wherein each item of the user-generated content is associated with an entity;
providing a prompt to a large language model (LLM) to analyze the plurality of items to generate a plurality of facets;
generating a user interface that includes information about the entity and one or more user interface elements, each user interface element corresponding to a respective facet of the plurality of facets;
receiving user selection of a particular user interface element of the one or more user interface elements; and
in response to the user selection of the particular user interface element, updating the user interface to display one or more items of the plurality of items of user-generated content that are associated with the facet corresponding to the particular user interface element.

7. The computing device of claim 6, wherein the operations further comprise pruning the plurality of facets.

8. The computing device of claim 6, wherein each facet of the plurality of facets is associated with a respective category, and wherein the operations further comprise storing the category associated with the facet corresponding to the particular user element in a database.

9. The computing device of claim 8, wherein the operations further comprise identifying one or more particular categories that meet a user selection threshold, and wherein providing the prompt to the LLM includes providing the prompt that includes the one or more particular categories.

10. The computing device of claim 6, wherein generating the user interface comprises:
identifying a subset of facets that match a user profile or a user context; and
generating the one or more user interface elements, each user interface element corresponding to a respective facet of the subset of facets.

11. A non-transitory computer-readable medium with instructions stored thereon that, when executed by a processor, cause the processor to perform operations comprising:
obtaining a plurality of items of user-generated content, wherein each item of the user-generated content includes at least one of text, image, audio, video, or combinations thereof, and wherein each item of the user-generated content is associated with an entity;
providing a prompt to a large language model (LLM) to analyze the plurality of items to generate a plurality of facets;
generating a user interface that includes information about the entity and one or more user interface elements, each user interface element corresponding to a respective facet of the plurality of facets;
receiving user selection of a particular user interface element of the one or more user interface elements; and
in response to the user selection of the particular user interface element, updating the user interface to display one or more items of the plurality of items of user-generated content that are associated with the facet corresponding to the particular user interface element.

12. The non-transitory computer-readable medium of claim 11, wherein the operations further comprise pruning the plurality of facets.

13. The non-transitory computer-readable medium of claim 11, wherein each facet of the plurality of facets is associated with a respective category, and the operations further comprise storing the category associated with the facet corresponding to the particular user element in a database.

14. The non-transitory computer-readable medium of claim 13, wherein the operations further comprise identifying one or more particular categories that meet a user selection threshold, and wherein providing the prompt to the LLM includes providing the prompt that includes the one or more particular categories.

15. The non-transitory computer-readable medium of claim 11, wherein generating the user interface comprises:
identifying a subset of facets that match a user profile or a user context; and
generating the one or more user interface elements, each user interface element corresponding to a respective facet of the subset of facets.
